(19) United States
(12) Patent Application Publication
(10) Pub. No.: US 2025/0230943 A1
(43) Pub. Date: Jul. 17, 2025

(54) METHOD, DEVICE AND SYSTEM FOR DETERMINING AN AMOUNT OF THERMAL ENERGY SUPPLIED TO A ROOM IN A BUILDING OVER A GIVEN PERIOD

(71) Applicant: KOCLIKO, BORDEAUX (FR)

(72) Inventors: Eric Emmanuel VORGER, BORDEAUX (FR); Renaud Marcel NÉDÉLEC, BORDEAUX (FR); Maxime Serge ROBILLART, BORDEAUX (FR); Fabio MUNARETTO, BORDEAUX (FR)

(21) Appl. No.: 18/698,411

(22) PCT Filed: Oct. 4, 2022
(86) PCT No.: PCT/EP2022/077589

§ 371 Date: Apr. 4, 2024

(30) Foreign Application Priority Data
Oct. 5, 2021 (FR) 2110545

(51) Int. Cl. F24F 11/47; F24F 11/64; F24F 110/10; F24F 110/12; F24F 130/10; F24F 130/20

(52) U.S. Cl. CPC F24F 11/47; F24F 11/64; F24F 2110/10; F24F 2110/12; F24F 2130/10; F24F 2130/20

(57) ABSTRACT

The invention relates to a method (100) for determining an amount of thermal energy supplied to a premises (20) in a building (2) over a given period, by a collective heat management device (30), said determination, carried out by one or more processors, including the use of a plurality of ambient temperature values for the building, a value of the temperature outside the building (2), a volume of the premises (20) in the building, and a heat loss coefficient, said method being characterised in that the heat loss coefficient was calculated (130) from a thermal simulation model (41) of the building, taking into account the geometry of the premises and the composition of the walls.

The invention also relates to an allocator (10) for determining an amount of thermal energy supplied by a collective heat management device (30), and a system (1) for allocating heating costs comprising an allocator (10) according to the invention.

### TECHNICAL FIELD

The invention relates to the field of buildings, in particular to the management of thermal energy in a building. In particular, it relates to a method for determining an amount of thermal energy supplied to a premises in a building over a given period. The invention relates, in addition, to a device and a system for determining an amount of thermal energy supplied to a premises in a building, in particular for the allocation of energy costs.

### PRIOR ART

The known prior art on the basis of which the invention has been developed is described below.

In the context of the objectives set in the Paris agreement, the European Union fixed ambitious objectives for energy transition by 2030 and 2050, focusing on the increase in the penetration of renewable energies, energy efficiency and the reduction of greenhouse gas emissions.

In 2016, buildings represented nearly 40% of the final energy consumption of the European Union. Thus, although there are large disparities in the performance of buildings from one country to another, this sector presents a significant margin for progress in terms of energy efficiency. In particular, heating and cooling in the residential sector, services and industry represent approximately 50% of the provision of primary energy in the EU (European Commission-Information sheet-16 Feb. 2016). In particular, the origin of primary energy for residential heating relies mainly on fossil fuels (82% in 2016) and 68% of total gas imports into Europe are attributable to the heating and cooling sector.

This makes heating of buildings a prime target for meeting the energy transition objectives by 2030 and 2050.

Thus, buildings have been the subject of numerous studies and models aimed at characterising their energy performance. For example, dynamic thermal simulations (DTS) of buildings have been proposed. These studies, mainly intended for building owners, make it possible to simulate the energy performance of various envisaged technical solutions, with, for example, comparisons of CMV, heat generators or even artificial lighting management solutions. These studies, based on dynamic thermal simulations of are also implemented in construction project programs for analysing thermal comfort in summer in the absence of air-conditioning or for quantifying heating needs.

Such simulations have also been proposed for estimating forecast consumptions. However, buildings are complex and non-stationary energy systems. Thus, important variations are observed between the consumptions forecast in simulations and measured consumptions due to errors in the input data, occupation scenarios or environmental conditions. In addition, these simulations are generally based on heavy software clients, and are not used in embedded systems configured to perform the analysis in real time. It was recently proposed to model a building and its systems, in order to optimise its energy management (Hugo Viot. Modélisation et instrumentation d′un bâtiment et de ses systèmes optimiser sa gestion énergétique. University of Bordeaux, 2016. In French. NNT: 2016BORD0349; tel. +33 (0) 1503037). In particular, given that DTS models are deemed to be too heavy, the construction of models with small dimensions has been proposed in order to be able to embed them in a controller to improve energy management. Nevertheless, such simplified models have performances which could be improved. In addition, their performance will depend largely on the learning base used, and a model could require training for each new building, given that one given building does not behave in the same way as another.

Thus, in the absence of being able to efficiently predict this consumption, monitoring has been put in place and, in particular in the context of RT2012, a minimum monthly metering of the energy consumption is required, per position and per energy type. However, this only constitutes monitoring and not a measure to promote energy transition.

In this respect, in a collectively heated apartment building, the division of heating costs is usually made according to the share of ownership, or pro rata on the basis of the surface area of the apartment. Such a division does not encourage frugality, because even if the heating consumption differs from one dwelling to another, the heating costs remain calculated as a function of the surface area or share of ownership of the apartment.

Thus, beyond the evaluation of the improvement in energy performance of buildings, in order to make occupants responsible, an individualisation of heating costs has been implemented in France. The individualisation (or allocation) of heating costs enables payment according to what each apartment has actually consumed. The occupants are thus encouraged to control their consumption and to avoid energy waste. The individualisation of heating costs enables energy economies to be achieved on the order of 15% on average, and reductions in the bills for inhabitants wishing to adapt their consumption (ADEME. September 2019. ISBN 979-10-297-1399-6).

In order to be able to account for what each occupant consumes, it is necessary to install measurement devices that can be read remotely. Two main devices currently share the market: individual thermal energy meters (TEM) and heat cost allocators (HCA).

TEMs are placed at the entry to each dwelling and display the actual heating consumption, enabling the occupants to monitor their consumption. HCAs are put in place when it is technically impossible or unprofitable to install TEMs. HCAs utilise measurement of the surface temperature of heat emitters. They are placed on each radiator of the dwelling. There are three major operating modes for “conventional” HCA. They are defined by standard NF EN 834: i) single probe measurement method (probe measuring the surface temperature of the heating body or the temperature of the heat transfer fluid); ii) two-probe measurement method (one probe measuring the surface temperature of the heating body or the temperature of the heat transfer fluid, and another probe measuring the ambient temperature); and iii) multiple-probe measurement method (a plurality of probes for measuring the average temperature of the heat transfer fluid, and one probe for the ambient temperature).

The installation objectives of these solutions are well below expectations. More specifically, mainly due to the complexity of installation of these systems, many buildings do not yet have individualisation of heating costs.

Moreover, these systems for allocating heating costs are not able to propose a reliable calculation of the energy consumed with respect to the positioning of the dwellings. More specifically, it has been proposed to calculate heating costs on the basis of a fixed part of 30%, coupled with the possibility of incorporating correction coefficients for taking into account unfavourable thermal situations (dwellings located to the north benefiting from less solar input, dwellings on the top floor suffering from larger heat losses, etc.). Nevertheless, these measures cannot accurately take into account the consumption of a dwelling. Thus, a strong inequity remains for the occupants as a function of the position of the dwellings.

In addition, these systems remain sensitive to “heat theft”. More specifically, a dwelling positioned at the centre of a building having a reduced heating will profit from the heat transferred from adjacent hot dwellings. Thus, there also remains an inequity associated with the use of individual thermal energy meters and allocators of actual heating costs.

There is therefore a need for a solution which can effectively determine (for example, in real time and accurately) the thermal energy consumption of a dwelling and in particular, the amount of thermal energy supplied by a collective heat management device to a premises in a building. In addition, such a solution should also enable more accurate calculation of heating costs and thus strengthen the fairness in the payment of heating costs in a collective building.

The invention aims to remedy these disadvantages of the prior art. In particular, the invention aims to propose a method for determining an amount of thermal energy supplied to a premises in a building over a given period, said method being able to determine such an amount precisely and accurately, and to do so without requiring costly installation of dedicated equipment. In addition, taking into account a thermal simulation model of the building and the fact of being able to take into consideration an ambient temperature in order to perform the allocation, enables compensation systems to be put in place which can improve the fairness between users and ultimately take into account a level of thermal comfort rather than a level of energy consumption.

In addition, the invention aims to propose an allocator for determining an amount of thermal energy supplied by a collective heat management device to a premises in a building, said allocator being able to operate on the basis of simple measurements of ambient temperatures and outside temperature of the building, in order to determine an amount of thermal energy supplied by a collective heat management device to a premises in a building.

### SUMMARY OF THE INVENTION

The invention aims to overcome these disadvantages.

The invention aims in particular to provide a method for allocating energy costs in a collective building including a plurality of individual premises and at least one collective heat management device, the method being applicable to all the individual premises of the collective building and comprising the determination of an amount of thermal energy supplied, by the at least one collective heat management device, to at least one individual premises of the collective building, over a given period, said determination, carried out by one or more processors, including the use of,
a thermal simulation model of the collective building which virtually represents the collective building and which takes into account, for each individual premises, a geometry of the individual premises and a composition of the walls of the individual premises, as well as the heat exchange between various premises of the collective building,
a plurality of ambient temperature values of the collective building, the plurality of ambient temperature values of the collective building including a plurality of temperatures of the individual premises and a plurality of temperatures of premises or common spaces of the collective building which are adjacent to the individual premises, one or more values of temperatures outside the collective building,
a volume of the individual premises, and
at least one heat loss coefficient of the individual premises, and calculation of the at least one heat loss coefficient of the individual premises on the basis of the thermal simulation model of the collective building.

The applicant has developed a method capable of rapidly calculating an amount of energy supplied to an individual premises based essentially on inside and outside ambient temperature data. In particular, it enables, in the context 41 present invention, use of as many heat loss coefficients as there are premises and, in certain advantageous embodiments, a plurality of heat loss coefficients can be associated with a same individual premises as a function of the period considered. The method can, in particular, be used to calculate heating costs and to incorporate a notion of fairness between the users of a same collective building.

According to other optional features of the method, said method can optionally include one or more of the following features, alone or in combination:
when the individual premises is additionally defined by a joinery composition, the thermal simulation model of the collective building is a model additionally taking into account the joinery composition. Thus, it is possible, by directly incorporating the joinery composition during the construction of the thermal simulation model of the collective building, to improve its performance without burdening the calculation.
the thermal simulation model of the collective building is a model additionally taking into account data representative of local solar radiation over the given period. Thus, it is possible, by directly incorporating data representative of solar radiation during the construction of the thermal simulation model of the collective building, to improve its performance without burdening the calculation.
the thermal simulation model of the collective building is a dynamic thermal simulation model of the collective building. The use of a dynamic thermal simulation model makes it possible to obtain, using the method according to the invention, determined amounts of heat supplied having an improved accuracy.
the heat loss coefficient of the individual premises is selected from at least two predetermined heat loss coefficients, said predetermined heat loss coefficients each corresponding to a time period. Thus, it is possible to choose, for example as a function of the season or the month of the year, the heat loss coefficient which will allow an amount of thermal energy supplied to be determined with greater accuracy.
the determination of the amount of thermal energy supplied by the at least one collective heat management device, to the at least one individual premises of the collective building, includes the use of one or more adjustment coefficients, each adjustment coefficient being apply to an adjustment variable measured or calculated for the given period; preferably the adjustment coefficient has been calculated on the basis of a dynamic thermal simulation model of the collective building. Thus, it is possible to adjust the amount of energy supplied, determined as a function of additional parameters that best describe the use of the individual premises. This will allow an amount of thermal energy supplied to be determined with greater accuracy.
the adjustment variable is selected from: a variable representative of the heat losses linked to the window openings, a variable representative of the level of occupation of the individual premises, a variable representative of the meteorological conditions, for example exceptional meteorological conditions, and/or a variable representative of the use of auxiliary heating. This makes it possible to incorporate actual uses which are measured directly or modelled for each individual premises without burdening the model and induces a higher accuracy.
the adjustment variable is measured directly in the individual premises, modelled in a probabilistic manner on the basis of statistics, or reconstructed on the basis of measurements of machine learning algorithms.
for each adjustment coefficient, the method has included a step of calculating a plurality of adjustment coefficient values, each as a function of a period in the year, and the value of the adjustment coefficient used in order to determine the amount of thermal energy supplied is a function of the given period. There is, for example, an adjustment coefficient value calculated for each month and as a function of the time; the value corresponding to the month considered is used.
it includes a calibration step of the thermal simulation model of the collective building, said calibration step is preferably carried out on the basis of a first measurement period and a Bayesian calibration algorithm, so that the predictions of consumption and inside temperatures, at hourly steps, of the thermal simulation model of the collective building reproduce the measurements as closely as possible.
it includes a calibration step of the thermal simulation model of the collective building, said calibration step is preferably carried out on the basis of a first measurement period of ambient and outside temperature values and of a Bayesian calibration algorithm, such that temperatures calculated by the thermal simulation model of the collective building reproduce as closely as possible the measured temperature values.
the ambient temperature of the individual premises corresponds to temperatures measured in a plurality of locations of the premises. The various locations can correspond to different rooms.
it includes a step of calculating individualised heating costs, for an individual premises, as a function of a determined amount of thermal energy supplied by the collective heat management device, to said individual premises.
the step of calculating individualised heating costs takes into account features of orientation and positioning of the individual premises in the collective building. This makes it possible to correct the disparities between the premises or common spaces of the collective building. This induces a principle of fairness in the allocation of heating costs and makes it possible to correct the disparities between the premises or common spaces of the collective building (for example different orientation, different floor, etc.). In addition, this enables tenants to pay the portion of the heating consumption for which they are truly responsible, namely the temperature to which they are heated.
it includes a step of calculating a confidence interval on the determined amount of thermal energy, preferably said calculation of a confidence interval including the use of at least one value of uncertainty over the one or more adjustment variables used during the determination of the amount of thermal energy supplied.
the calculation of at least one heat loss coefficient of the individual premises on the basis of a thermal simulation model of the collective building can include, for an individual premises, calculating at least one heat loss coefficient on the basis of a plurality of simulations in which the geometry values of the individual premises and composition of the walls and optionally the joinery composition have been modified in such a way as to incorporate the uncertainties associated with the collective building.
the calculation of at least one heat loss coefficient of the individual premises on the basis of a thermal simulation model of the collective building can include, for an individual premises, the calculation of at least one heat loss coefficient on the basis of a plurality of simulations in which, in addition, values for use and/or meteorological conditions have been modified in such a way as to incorporate the uncertainties associated with the uses and with the meteorological conditions.

According to a second object, the invention relates to an allocator of energy costs in a collective building including a plurality of individual premises and at least one collective heat management device, the method being applicable to all the individual premises of the collective building and comprising the determination of an amount of thermal energy supplied by the at least one collective heat management device, to at least one individual premises of the collective building, said allocator comprising one or more processors configured to determine the amount of thermal energy supplied, by using,
a thermal simulation model of the collective building which virtually represents the collective building and which takes into account, for each individual premises, a geometry of the individual premises and a composition of the walls of the individual premises, as well as the heat exchange between various premises of the collective building,
a plurality of ambient temperature values of the collective building, the plurality of ambient temperature values of the collective building including a plurality of temperatures of the individual premises and a plurality of temperatures of premises or common spaces of the collective building which are adjacent to the individual premises,
one or more values of temperatures outside the collective building,
a volume of the individual premises, and
at least one heat loss coefficient of the individual premises which describes the proportion of the thermal energy supplied to the individual premises which is transferred to the premises or common spaces adjacent to the individual premises, said allocator being characterised in that said allocator is configured to calculate the at least one heat loss coefficient of the individual premises on the basis of the thermal simulation model of the collective building.

In a particular implementation, when the individual premises is additionally defined by a joinery composition, the allocator is characterised in that the thermal simulation model of the collective building additionally takes into account the joinery composition.

Preferably, the allocator is such that the thermal simulation model of the collective building is a model additionally taking into account data representative of local solar radiation over the given period.

As will be described below, the allocator possesses a plurality of heat loss coefficients, each dedicated to an individual premises. In addition, a premises can be associated with a plurality of heat loss coefficients, each dedicated to a given period.

According to a third object, the invention relates to a system for allocating heating costs, including an allocator according to the invention. Such an allocation system enables, in particular, tenants to pay the portion of the heating consumption for which they are truly responsible, namely the temperature to which they are heated.

### BRIEF DESCRIPTION OF THE FIGURES

Other features and advantages of the invention will be better understood on reading the following description with reference to the attached drawings, given for illustrative purposes and in no way limiting.

FIG. 1 represents a method according to an embodiment of the invention.

FIG. 2 represents a system for determining an amount of thermal energy supplied by a collective heat management device according to an embodiment of the invention.

For the purposes of illustration, the figures do not necessarily reflect the scales, in particular in terms of thickness.

Aspects of the present invention are described with reference to flow diagrams and/or block diagrams of methods, devices (systems) and computer program products according to embodiments of the invention.

In the figures, the flow diagrams and block diagrams illustrate the architecture, functionality and operation of possible implementations of systems, methods and computer program products, according to various embodiments of the present invention. In this regard, each block in the flow diagrams or block diagrams can represent a system, device, module or code, which comprises one or more executable instructions for implementing the one or more specified logic functions. In certain implementations, the functions associated with the blocks can appear in a different order than that indicated in the figures. For example, two blocks shown successively can, in fact, be executed substantially simultaneously, or the blocks can sometimes be executed in reverse order, as a function of the functionality involved. Each block of the block diagrams and/or flow diagram, and combinations of blocks in the block diagrams and/or flow diagram, can be implemented by special hardware systems which execute the function or action specified or execute combinations of special hardware and computer instructions.

### DESCRIPTION OF THE EMBODIMENTS

Below, a summary of the invention and the associated vocabulary is described, before presenting the disadvantages of the prior art, and finally showing in more detail how the invention overcomes these.

The expression “heat loss coefficient”, also called the overall volume heat loss coefficient of the building corresponds to the overall performance of the insulation in terms of heat losses per degree of difference between the inside and outside environments. The overall volume heat loss coefficient of the building expresses the heat losses per unit of heated volume. It is generally expressed in watts per cubic metre for a variation of 1 degree Celsius between the outside and inside temperature (watts/m³ and ° C.). The coefficient G was introduced at the time of the thermal legislation of 1974: “Order of 10 Apr. 1974 relating to thermal insulation and automatic control of heating installations in residential buildings”; in general it can vary from 0.5 to 3 watts/m³ and ° C.

In the remainder of the description, the expression “premises in a building” corresponds to a part of a building which can consist of one or more rooms. The premises can, for example, correspond to offices or to a habitation. Thus, the expression “volume of the premises” corresponds to the volume of one or more rooms in a building.

The expression “individualised heating costs” corresponds to calculated heating costs, in general for a premises in a building, on the basis of the actual consumption of the premises, this consumption being established on the basis of devices which determine the amount of heat or cold consumed within each premises.

The expression “thermal simulation model” may correspond, in the context of the invention, to a model configured to virtually represent the building and to describe its behaviour in the face of stresses linked to climate or to the behaviour of the users (these stresses can be modelled stochastically). In particular, the expression “dynamic thermal simulation of the building” may correspond, in the context of the invention, to a model configured to calculate the change over time in the thermal state of a building. It makes it possible, in particular, to determine at all the chosen times of a simulation, the temperature at a certain number of points of the elements which compose it and which evolve according to the various laws heat governing exchange (convection, conduction, radiation, change of state). Thus, a thermal simulation model can estimate the thermal needs of a building by taking account of the shell of the building and its inertia, various thermal inputs, the behaviour of the occupants and the local climate.

The expression “local solar radiation” can correspond, in the context of the present invention, to the amount of solar energy received per unit surface area. It can, for example, be expressed in watts per square metre (watts/m2).

The term “correlation model” or “algorithm”, should be understood, within the meaning of the invention, as a finite sequence of operations or instructions enabling a value to be calculated on the basis of one or more input values. The implementation of this finite series of operations makes it possible, for example to attribute a value Y, such as a label Y, to an observation described by a set of features or parameters X used, for example, to implement a function ƒ, that is able to reproduce Y having observed X.

with:

$$Y = f ( X ) + e$$

e: the noise or measurement error.

The term “supervised machine learning model” shall be understood, within the meaning of the present invention, to mean a correlation model that is automatically generated on the basis of data, called observations, which have been labelled.

The term “non-supervised machine learning model” shall be understood, within the meaning of the present invention, to mean a correlation model that is automatically generated on the basis of data, called observations, which have not been labelled.

The terms “process”, “calculate”, “determine”, “display”, “transform”, “extract”, “compare” or more broadly “executable operation”, within the meaning of the invention, shall be understood as actions carried out by a device or processor unless otherwise indicated by the context. In this regard, the operations relate to actions and/or processes of a data processing system, for example a computer system or an electronic computing device, which handles and transforms the data represented as physical (electronic) quantities in the memories of the computer system storage devices, transmission or display of the information. These operations may be based on applications or software.

The terms or expressions “application”, “software”, “program code”, and “executable code” mean any expression, code or notation, of a set of instructions intended to cause data processing in order to carry out a particular function directly or indirectly (for example, after a conversion operation to another code). The program code examples can include, but are not limited to, a sub-program, function, executable application, source code, object code, library and/or any other sequence of instructions designed for execution on a computer system.

The term “processor”, within the meaning of the invention, shall mean at least one hardware circuit configured to execute operations according to the instructions contained in a code. The hardware circuit can be an integrated circuit. Examples of a processor comprise, but are not limited to, a central processing unit, a graphic processor, an application-specific integrated circuit (ASIC) and a programmable logic circuit.

The term “electronic device” shall mean any device comprising a processing unit or a processor, for example in the form of a microcontroller cooperating with a data memory, optionally a program memory, said memory being able to be dissociated. The processing unit cooperates with said memories by means of an internal communication bus.

The term “coupled”, within the meaning of the invention, shall mean connected, directly or indirectly with one or more intermediate elements. Two elements can be mechanically or electrically coupled, or linked by a communication channel.

The term “precise” or “precision”, “reliable” or “reliability”, “accurate” or “accuracy” shall mean repeatable and exact measurements. In addition, this means that the measurements are free from error or, at the very least, that they have an error rate less than for example 5%, preferably 2% and most preferably less than 1%. Furthermore, the expression “improved accuracy” may correspond, within the meaning of the invention, to a very exact consumption; the value of which has a precision with an error rate less than, for example, 5%, preferably 2% and most preferably less than 1%.

Individual thermal energy meters (TEM) exist, but these systems are expensive and complex to install (one meter is required per hot water loop and their installation requires plumbing work). Heat costs allocators (HCA) also exist, based on the measurement of the surface temperature of radiators. Nevertheless, these systems are not precise and are complex to install (in particular, they must be installed on each of the radiators). Neither TEMs nor HCAs enable fairness to be established for the occupants of a building.

The inventors have developed a solution making it possible, without installation of heavy electronic devices, to determine an amount of thermal energy supplied to a premises in a building over a given period.

In particular, they have developed a determination solution that takes into account a heat loss coefficient of the premises, having been calculated on the basis of a thermal simulation model of the building, taking into account the geometry of the premises and the composition of the walls. Furthermore, if the premises comprise joinery, the thermal simulation model of the building can also take into account the composition of this joinery. In addition, preferably, it can also take into account data representative of local solar radiation over a given period. Such a solution makes it possible to combine the precision of a solution using thermal simulation using heavy calculation systems, with the responsiveness and lightness of a solution based on a heat loss coefficient. More specifically, it has been attempted to incorporate thermal simulation directly into methods for determining an amount of thermal energy supplied to a premises, but these solutions were not sufficiently precise and were generally too heavy to implement.

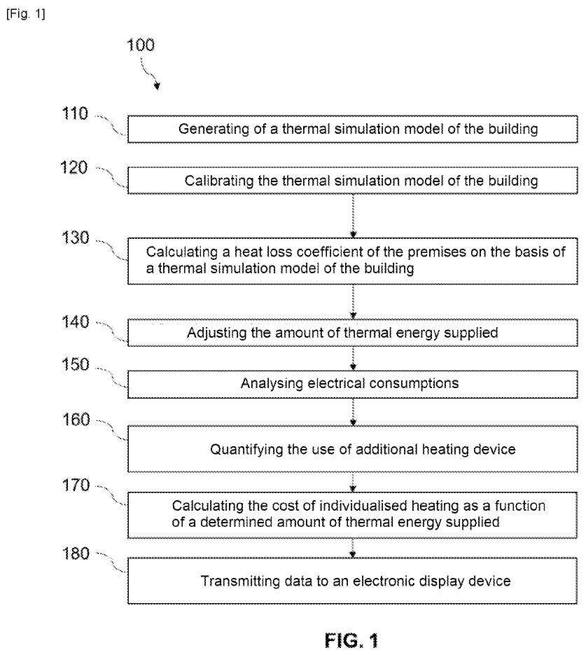

Thus, according to a first aspect, the invention relates to a method 100 for determining an amount of thermal energy supplied to a premises 20 in a building 2 as illustrated according to an example in FIG. 1.

The amount of thermal energy supplied to the premises 20 corresponds, for example, to the amount of energy supplied by a collective heat management device 30. The collective heat management device 30 generally corresponds to a collective gas boiler. Nevertheless, it can also correspond to another heating system, possibly electric, such as a heat pump or a heat network.

In particular, the determined amount of thermal energy supplied be relative. Nevertheless, preferably, the determined amount of thermal energy supplied will be expressed in an international unit of measurement of thermal energy, such as watt-hours. The amount of thermal energy supplied may, for example, correspond to a monthly amount.

Preferably, the premises 20 for which an amount of thermal energy supplied will be determined, corresponds to an individual premises, and more preferably a dwelling. The premises may be defined by a geometry. The geometry of the premises may correspond to the dimensions of the walls forming said premises. These dimensions may also refer to the dimensions of the joinery and may incorporate the orientation of the walls forming the premises. Preferably, the geometry of the premises 20 will include the surface area of the walls and optionally the surface area of the joinery, their positions in the building 2 and their orientations. In addition, the premises will be defined, in particular, by the composition of the walls and optionally by the joinery composition. More specifically, the function of the dimensions and characteristics of the materials used, the behaviour of the premises and therefore the amount of thermal energy to be supplied can vary.

The determination method 100 according to the invention, can advantageously calculate an amount of thermal energy supplied over a given period.

The given period will correspond, for example, to a week, a month, a quarter, a half-year or even a year. As will be detailed below, the present invention can take into account differential fluctuations associated with climate conditions (for example solar radiation) and the given period can preferably correspond to a period of time over which a single and same heat loss coefficient is used. Advantageously, the given period is a calendar period and it is preferably associated with the seasons.

In the context of the present invention, the determination of an amount of thermal energy supplied to a premises 20 in a building 2 includes the use of: a plurality of ambient temperature values of the building, a value of the temperature outside the building 2, a volume of the premises 20 of the building and a heat loss coefficient of the premises.

The ambient temperature values of the building can be supplied by temperature sensors dedicated to the determination method or temperature sensors incorporated in systems already installed in the building. The ambient temperature sensors will preferably be temperature sensors connected to a communication network (e.g., Internet, wifi®, sigfox®, LoRa®, LoRaWAN® Zigbee®, Z-Wave®, Enocean®, 3G/4G/5G). The ambient temperature values of the building can preferably include a plurality of temperatures of a premises to be studied and temperatures of premises adjacent to the premises to be studied (in other words for which an amount of thermal energy supplied must be determined) or of common spaces adjacent to the premises to be studied.

An ambient temperature of the premises 20 can correspond to temperatures measured at least every hour in a plurality of locations (i.e. rooms) of the premises 20. The ambient temperature values used of the premises 20 can also correspond to mean or median values.

In particular, the determination can include the use of at least two ambient temperature measurement locations of the premises 20 (preferably a day zone and a night zone).

The determination method can use one or more values of temperature outside the building 2. The one or more temperatures outside the building can be supplied by temperature sensors dedicated to the determination method or temperature sensors incorporated in systems already installed around or on the building. The outside temperature sensors will preferably be temperature sensors connected to a communication network (e.g., Internet, wifi®, sigfox®, LoRa®, LoRaWAN®, Zigbee®, Z-Wave®, Enocean®, 3G/4G/5G). Alternatively, the temperature values outside the building could correspond to local outside temperature values measured or calculated for a geographical area in which the building 2 is located. The temperature values outside the building could also correspond to local outside temperature values estimated for a geographical area in which the building 2 is located.

The volume of the premises 20 of the building will generally correspond to a value that is known or calculated considering the geometry of the building and the premises in particular. In certain embodiments, the volume of the premises can correspond to a plurality of volumes each associated with one or more spaces of the premises. For example, the determination of the amount of thermal energy supplied to a premises 20 can take into consideration a particular volume for each ambient temperature value of the premises used. A rather hot zone associated with temperature values may be associated with a sub-volume of the premises 20, while a rather cool zone will be associated with other temperature values and with another sub-volume of the premises 20.

In the context of the present invention, the determination of the amount of thermal energy supplied to a premises will be based on a heat loss coefficient of the premises calculated on the basis of a thermal simulation model 41 of the building 2.

The calculation of the heat loss coefficient of the premises on the basis of a thermal simulation model 41 of the building 2 makes it possible to obtain a much more precise and accurate heat loss coefficient of the premises, than the heat loss coefficients calculated or estimated by other biases.

Preferably, the thermal simulation model 41 of the building used to calculate the heat loss coefficient of the premises is a dynamic thermal simulation model of the building. More specifically, a dynamic thermal simulation model will be based on a precise description of the geometry and of the composition of the walls. Furthermore, if the premises comprise joinery, the thermal simulation model of the building can also take into account the composition of this joinery. This will enable relevant physical phenomena (heat exchange by convection, conduction, radiation) to be taken into account and thus enable a precise calculation of the amount of thermal energy supplied to the premises.

Other methods than the 3CL method for calculating conventional consumption of dwellings, used in order to produce EPCs, exist. However, these methods are based on a rougher description of heat loss surface areas and a rougher modelling of heat exchanges. For example, the 3CL method does not incorporate a consideration of dynamic aspects unlike the present invention based preferably on a dynamic thermal simulation model of the building. It only allows annual consumption of heating/cooling/DHW to be calculated, but not, for example, change in temperature over time. Moreover, it only applies to an analysis of the frame without taking into account the uses. De facto, it will be less precise than the method according to the present invention, which preferably enables calculation to be performed at hourly time steps, on both the consumption and the inside temperatures, while being able to take into account the uses.

Thus, the thermal simulation model of the building advantageously takes into account the geometry of the premises, the composition of the walls, optionally the joinery composition and the stresses to which the building is subject, such as preferably the climate and uses.

In the context of the invention, a dynamic thermal simulation model (DTS) will make it possible to calculate the change over time in the thermal state of a building, using a numerical model approximated to it. This model then makes it possible to obtain, at all the chosen times of the simulation, the temperature at a certain number of points of the building, which change according to the various laws governing heat exchange (convection, conduction, radiation, change of state).

Thus, a dynamic thermal simulation model in the context of the invention can estimate the thermal needs (heating and cooling needs) and the temperatures in each zone of the building in operation. This model takes account of the shell of the building and its inertia (based on a description of the internal and external walls of the building), heat exchange flows between thermal zones, various thermal inputs, the behaviour of the occupants and of the local climate. In addition, advantageously, when the model is used to estimate the actual energy consumption, the calculation can also take account of the energy systems (production system, emitter types, etc.).

The thermal simulation model is preferably a multi-zone model, more preferably with finite volumes and even more preferably reduced by modal analysis. Such a configuration can reduce the calculation time by a factor of three. In addition, at each time step, the model is configured to determine the heating and cooling needs and/or the temperatures in each zone of the building. The model is advantageously configured to incorporate the heat exchange between zones, for example between premises 20. In addition, the model is advantageously configured to take into account the thermal inertia at each wall.

In addition, in order to further improve the precision and accuracy of the determination according to the invention, the thermal simulation model 41 of the building 2 that is used can advantageously additionally take into account data representative of local solar radiation.

The taking into account of data on local solar radiation in particular per time period (e.g. given period) can take into account the energy input solar radiation, whatever form that it may take, direct or indirect.

In particular, the local solar radiation data include the overall horizontal radiation and the diffuse horizontal radiation. These values, for a given building 2, will vary strongly as a function of the period considered. In addition, for a given period, the influence of solar radiation on two premises in different geographic situations (e.g. location and/or orientation) can be significantly different. Thus, in the context of the present invention, it is very advantageous to use a thermal simulation model 41 of the building 2 taking into account local solar radiation data for the period studied (i.e.: period of time) or data representative of local solar radiation for the period studied.

The local solar radiation data or the data representative of local solar radiation may have been constructed on the basis of local historical data and they are preferably modelled on the basis of local historic data. More specifically, the measurements of certain values of radiation are particularly expensive to obtain if they have to be obtained for each of the studied buildings.

Alternatively, the data representative of local solar radiation have been obtained from at least one instrumental device or from a computer server including data relating to local solar radiation.

Various embodiments of a method for determining an amount of thermal energy supplied to a premises 20 in a building 2 over a given period according to the invention will now be described.

As illustrated in FIG. 1, a determination methods according to the invention can include a step 110 of generating a thermal simulation model of the building.

Many tools exist for generating 110 a thermal simulation model of the building. The thermal simulation model of the building 2 is preferably constructed on the basis of a computer solution combining one or more libraries dedicated to the elements necessary for the description of a building, and a modelling module enabling the studied building 2 to be graphically described in 3D. Thus, it is possible to create digital models of the building 2 including all the information on the materials, joinery, equipment and energy performance.

Beyond these aspects, the generation and use of a dynamic thermal simulation model of the building will make it possible to obtain much better results. More specifically, it is possible to use modelling solutions capable of additionally incorporating environmental impacts and, in particular, the factors associated with light radiation.

The thermal simulation model 41 of the building 2 used in the context of the calculation of the heat loss coefficient of the premises is preferably a dynamic thermal simulation model which can include characteristics of surrounding solar masks.

In particular, the thermal simulation model 41 of the building 2 used in the context of the calculation of the heat loss coefficient of the premises includes characteristics of the composition of the walls and optionally the joinery composition. It can advantageously additionally include characteristics of air renewal flow rate and/or distribution losses of the heating network.

In addition, the thermal simulation model 41 of the building 2 is a dynamic thermal simulation model including characteristics concerning the occupation of the building such as the hours of occupation and/or a level of occupation. In addition, it can include characteristics such as specific electrical uses, temperature settings for heating or air-conditioning, and/or heating or air-conditioning schedules.

Advantageously, the thermal simulation model 41 of the building 2 is also a dynamic thermal simulation model configured to take into account the heat exchange between the premises 20, 20b of a given building 2.

As illustrated in FIG. 1, a determination method according to the invention may advantageously include a step 120 of calibrating a thermal simulation model of the building. Such a step will be able to increase the precision of the method and therefore of the value of the determined amount of thermal energy supplied.

The calibration step 120 can be carried out on the basis of a first measurement period and a calibration algorithm, preferably a Bayesian calibration algorithm, such that the predictions of consumption and inside temperatures, at hourly time steps, of the thermal simulation model of the building more closely reproduce the measurements.

The calibration step 120 can make the thermal simulation model more reliable, in such a way as ensure that it reproduces as accurately as possible the actual thermal behaviour of the building 2. The objective of this step is to obtain a reliable and precise representation of the actual behaviour of the building by reconciling in-situ measurements (on the basis of ambient and outside temperature data) and outputs of the thermal simulation model (temperatures and consumption simulated by the model).

Thus, this step, on the one hand, can incorporate the measurements coming from a digital model generated by the thermal simulation model and, on the other hand, can calibrate the model by taking into account sources of uncertainties and errors which can explain the differences between the simulated data and the measurements. Advantageously, the estimation of the error is based on the use of a Bayesian calibration algorithm.

Thus, this calibration step 120 can cause a modification of the parameters of the thermal simulation model, and this modification will reflect on the value of the heat loss coefficient of the premises generated for a given period. In the context of the present invention, the thermal

simulation model 41 of the building 2 can be calibrated, as a function of the periods considered, under sunlight conditions varying by at least 50 Wh/m², for example by at least 100 Wh/m²; with outside temperature varying by at least 10° C., preferably by at least 30° C. In addition, it can be calibrated as a function of the periods considered, under outside relative humidity conditions varying by at least 15%. More specifically, the inventors have determined that these particular variables with these amplitude levels were the most suitable in the context of the present invention, in order to supply an amount of thermal energy that is determined as accurately as possible.

In addition, a method for determining an amount of thermal energy supplied to a premises 20 in a building 2 over a given period, in particular if it includes a prior calibration step, may include a step of calculating an uncertainty score of the value of the determined amount of thermal energy supplied.

In particular, this uncertainty score may be calculated on the basis of a variable generated during the calibration procedure and representing the deviation between the consumption predictions and inside temperatures at hourly time steps of the thermal simulation model of the building and the measurements.

As illustrated in FIG. 1, a determination method according to the invention may advantageously include calculation step 130 of at least one heat loss coefficient of the premises on the basis of a thermal simulation model of the building.

The heat loss coefficient, for each premises 20, can therefore be calculated on the basis of a non-calibrated, or preferably calibrated, thermal simulation model of the building. The heat loss coefficient estimated in this way can advantageously correspond to the expected heat losses in a premises 20 under variable operating conditions of the building 2. This calculation minimises the error made in the estimation of heat losses. This error can be rather large when a purely statistical calculation is performed, which does not take into account the inertia of the building for the dynamic aspect of the stresses that it undergoes (weather, uses, etc.).

As has been mentioned, ideally, the calculation of the heat loss coefficient requires taking into account many elements such as the type, surface area and orientation of the various walls (glazed or not) of the dwelling, but also the adjoining contacts, air renewal, various thermal bridges as well as the free inputs linked to solar inputs and uses (metabolic heat, specific electricity). In this context, the use of a calibrated thermal simulation model for estimating this heat loss coefficient is of great interest. The aim of the calculation of the heat loss coefficient of the premises is to be capable of estimating the value of the coefficient G of the premises 20 while taking into account the different sources of uncertainties linked to the building 2 and to its environment (uncertainties linked to the frame, systems, uses and meteorological conditions).

An uncertainty analysis can be carried out aimed at quantifying the variability of the outputs of the calibrated thermal simulation model of the building (and in particular the consumption) induced by the uncertainty in the input factors of the model. According to an embodiment, in order to perform this uncertainty analysis, each static parameter is defined by a probability density function on the one hand, and models of variabilities in uses and meteorological conditions are used on the other hand. For example, more than 500 simulations can be performed on the basis of these data, in such a way as obtain a dispersion of consumption results for each premises 20, and one or more heat loss coefficients G of the premises can then be recalculated on the basis of these simulations.

Thus, the calculation 130 of at least one heat loss coefficient of the individual premises on the basis of a thermal simulation model of the collective building can preferably include, for an individual premises 20, calculating at least one heat loss coefficient on the basis of a plurality of simulations in which the geometry values of the individual premises 20 and composition of the walls and optionally the joinery composition have been modified in such a way as to incorporate the uncertainties associated with the collective building 2.

More preferably, the calculation 130 of at least one heat loss coefficient of the premises on the basis of a thermal simulation model of the building can include, for a premises, the calculation of at least one heat loss coefficient on the basis of a plurality of simulations in which, in addition, the values for use and/or meteorological conditions (temperatures and sunshine) have been modified in such a way as to incorporate the uncertainties associated with the uses and with the meteorological conditions. In these embodiments, the values can be modified according to probability density functions and/or models of variability.

The use of an uncertainty analysis in order to calculate the coefficients G makes it possible to bring greater accuracy to the invention, compared with conventional methods, without burdening its operation.

In addition, the determination method according to the invention may include the use of a plurality of heat loss coefficients for a given premises 20, each calculated on the basis of the thermal simulation model of the building. Preferably, the determination method according to the invention will include the use of at least four heat loss coefficients. Advantageously, these heat loss coefficients will be specific to a given period and, for example, to a calendar period. More preferably, in the context of the method, the heat loss coefficient of a premises 20 is selected from at least two, preferably at least three and more preferably at least four heat loss coefficients, each of the heat loss coefficients corresponding to a period of the year. Even more preferably, the heat loss coefficient is selected from at least 12 heat loss coefficients (monthly coefficient) for a given premises 20.

A determination method according to the invention may include a calculation step 130 of a plurality of heat loss coefficients on the basis of a single same thermal simulation model of the building, or on the basis of various thermal simulation models of the building.

A determination method according to the invention will include a determination of an amount of thermal energy supplied to a premises 20 in a building 2 over a given period.

As has already been explained, the determination takes into account a plurality of ambient temperature values of the building, one or more temperature values outside of the building 2, a volume of the premises 20 of the building and a heat loss coefficient of the premises.

This determination can be compared with the calculation carried out by a heat cost allocator using a measurement of the ambient temperature of the premises. In particular, the determination according to the invention may correspond to an estimation, on the basis of a plurality of ambient temperature values and one or more outside temperature values, of the amount of energy consumed privately in the premises before being the subject of an allocation.

The calculation may, for example, have the following form:

$$E = {\int }_{t = 0}^{{t}_{final}} G . V . ( Ta ( t ) - Te ( t ) ) dt \qquad [ MATH1 ]$$

with:
E: the amount of energy consumed privately in the studied premises 20
Ta: the ambient temperature of the studied premises 20
Te: the temperature outside the building 2
V: the volume of the studied premises 20
G: the heat loss coefficient of the studied premises 20
t: the time step

Example of a formula with an adjustment variable:

$${\int }_{t = 0}^{{t}_{final}} [ G . V . ( Ta ( t ) - Te ( t ) ) + {C}_{adjustment} . {V}_{adjustment} ( t ) ] dt \qquad [ MATH2 ]$$

with:
E: the amount of energy consumed privately in the studied premises 20
Ta: the ambient temperature of the studied premises 20
Te: the temperature outside the building 2
V: the volume of the studied premises 20
G: the heat loss coefficient of the studied premises 20 C_{adjustment}: the adjustment coefficient linked to the adjustment variable
V_{adustment}: the adjustment variable
t: the time step

As described, the present invention can be implemented without an adjustment variable, with an adjustment variable or with a plurality of adjustment variables.

Advantageously, the determination may incorporate the use of one or more adjustment coefficients calculated on the basis of the thermal simulation model of the building. The use of these adjustment coefficients in combination with adjustment variables representative of environmental factors can further improve the accuracy of the model.

Thus, the according method to the invention advantageously includes an adjustment step 140 of the amount of thermal energy supplied, said adjustment step 140 including the use of one or more adjustment coefficients, each adjustment coefficient being applied to an adjustment variable.

The one or more adjustment variables may correspond to human or environmental factors having an impact on the thermal energy to be supplied to the premises. Thus, an adjustment variable can correspond to meteorological data, such as atmospheric pressure or wind speed.

An adjustment variable may be measured directly in the premises 20 of the building 2. Alternatively, an adjustment variable may be measured in a geographic area in which the building 2 is positioned. Another means of obtaining an adjustment variable may be to model it, for example probabilistically on the basis of statistics, or to generate it based on machine learning algorithms.

An adjustment variable is preferably calculated based on weekly, daily or hourly data. These values may be incorporated in such a way as generate a monthly value. In particular, if the heat loss coefficient is monthly, the adjustment variable is also monthly.

For example, the determination of the amount of thermal energy supplied to a premises 20 can incorporate the use of an adjustment variable selected from: a variable representative of heat losses linked to the window openings and/or to natural ventilation; and/or a variable representative of the use of auxiliary heating. This makes it possible to incorporate the actual uses which are measured directly or modelled for each premises.

Preferably, the determination of the amount of thermal energy supplied to a premises 20 incorporates the use of an adjustment variable representative of the electricity consumption of the premises, including auxiliary heating.

The determination may also incorporate the use of an adjustment variable representative of the heat losses due to opening at least one window 24 of the premises.

In this case and in a preferred manner, the adjustment variable representative of heat losses linked to the window openings 24 may be calculated as a function of changes in ambient temperature of the premises and in the humidity in the premises. In particular, a time series of inside and outside temperatures and humidity may be used. Thus, this makes available a precise estimate of the duration of window openings, without the need to position a sensor on each window.

An adjustment coefficient will correspond, for example, to a value used with an adjustment variable value during determination of the amount of thermal energy supplied to a premises 20. In particular, this adjustment coefficient is used in an equation for determining the amount of thermal energy supplied to a premises 20. This adjustment coefficient value is preferably calculated on the basis of a thermal simulation model of the building 2.

An adjustment coefficient value may, for example, be updated at a frequency less than or equal to 3 months, preferably less than or equal to 2 months and more preferably less than or equal to 1 month. Thus, it is possible to best take into account the values of the adjustment variables as a function of the season or, more generally, the usual climate at a given period. Preferably, the method thus uses, for the same adjustment coefficient, a plurality of predetermined adjustment coefficient values as a function of the given period.

In the context of the method for determining the amount of thermal energy supplied to a premises 20 according to the invention, a plurality of adjustment variable/adjustment coefficient pairs will advantageously be used. Thus, it will be possible to calculate an amount of thermal energy supplied more accurately when compared with other systems.

In particular, the method according to the invention may include the use of a plurality of adjustment coefficients, the predetermined value of which is selected as a function of the given period. For example, an adjustment coefficient associated with an adjustment variable representative of heat losses due to the openings of at least one window 24 of the premises, will not have the same value in the month of July as in the month of November. Preferably, the method according to the invention includes the use of at least two adjustment coefficients, more preferably at least three adjustment coefficients and still more preferably at least four adjustment coefficients, for the same premises 20.

In addition, the use of adjustment variables and it possible to reduce the adjustment coefficients makes complexity of the calculation of the amount of thermal energy supplied, by ensuring a higher accuracy. Moreover, this makes it possible to use the thermal simulation model just once in order to produce numerous adjustment coefficient values and heat loss coefficient values of the premises in such a way as to flexibly adapt to the considered period of the year.

As has been mentioned, one of the advantages of the method according to the invention is to be able to calculate a confidence interval on the determined amount of thermal energy supplied.

The calculation of this confidence interval may rely on the use of uncertainty values for the adjustment variables used during the determination of the amount of thermal energy supplied.

The uncertainty values for the adjustment variables can be predetermined values or values calculated as a function of a plurality of variable adjustment values for a same period (e.g. standard deviation). Alternatively, or in addition, the calculation of this confidence interval can rely on the calculation of a value of uncertainty for the calculated amount of thermal energy supplied and the adjustment variables used.

The performance of the present invention is illustrated, in particular, by table 1 below.

TABLE 1

| | Prediction accuracy | |
|---|---|---|
| | Poorly insulated | Well insulated |
| | EPC < C | EPC >= C |
| Without DTS | 50 | 50 |
| +radiation | 55 | 55 |
| +auxiliary heating | 53 | 53 |
| +opening | 51 | 51 |
| With Coeff. calculated from a | 70 | 76 |
| DTS without radiation | | |
| With Coeff. calculated from a | 80 | 86 |
| DTS with radiation | | |
| +auxiliary heating | 89 | 92 |
| +opening | 82 | 88 |
| +opening + auxiliary heating | 100 | 100 |

Table 1 illustrates how the accuracy of the prediction is improved in comparison with conventional methods for determining an amount of thermal energy supplied to a premises 20 in a building 2 over a given period. More specifically, without the use of a heat loss coefficient calculated on the basis of a dynamic thermal simulation model, the results are far from reality and are not capable of correctly taking account of external factors such as radiation, window openings or auxiliary heating.

In addition, the table 1 illustrates that taking account of radiation in the context of a heat loss coefficient of the premises calculated on the basis of a dynamic thermal simulation can improve the accuracy, and even more so when the building is well insulated. In addition, table 1 illustrates that taking account of the adjustment variables (with their adjustment coefficient) window openings (“opening”) and use of auxiliary heating (“auxiliary heating”) can further improve the accuracy.

As has been described, the calculation of the heat loss coefficient of the premises G is preferably carried out via a propagation of uncertainties varying numerous parameters, which may include radiation and internal inputs (cf. uses). This makes it possible to take into account the average impact (expectation) of these variables (radiation, internal inputs, etc.).

In order to further adjust the calculation of consumption and to come yet closer to the actual energy consumption, the solution according to the invention proposes incorporating the adjustment variables. This enables the calculation of the consumption to be adjusted by considering the actual value of the variables. For example, during an adjustment associated with radiation, the calculation of the heat loss coefficient of the premises G can calculate an average consumption by considering an average effect of the radiation (for example, 1200 kWh/m² over the year, or 120 kWh/m² over the month). The fact of adding an adjustment variable to the radiation will enable the consumption calculation to be modified. For example, if in reality this is 1300 kWh/m² which is measured over the year (or 100 kWh/m² over the period). The calculation of the value of the heat loss coefficient G of the premises will be modified using an adjustment coefficient for the radiation and using the adjustment variable (for example

adjusted consumption=average consumption+Coeff×(1300/1200−1)).

As illustrated in FIG. 1, a determination method according to the invention may advantageously include a step 150 of analysing electrical consumptions.

In particular, the use of auxiliary heating can be detected on the basis of an analysis 150 of electrical consumptions. The analysis of these electrical consumptions may correspond to an estimation by statistical models, to a calculation based on analysis of electricity bills or even on measurements via electronic electricity meters.

Thus, as illustrated in FIG. 1, a determination method according to the invention may advantageously include a quantification step 160 of the use of an additional heating device.

This quantification step 160 of the use of an additional heating device may preferably be based, in particular, on data from electronic electricity meters or on the analysis of documents including consumption reports such as electricity bills.

As illustrated in FIG. 1, a determination method according to the invention may advantageously include a calculation step 170 of individualised heating costs as a function of a determined amount of thermal energy supplied.

In particular, the calculation 170 step of individualised heating costs may be a calculation step of individualised heating costs 170, for a premises 20 of the building 2, as a function of a determined amount of thermal energy supplied by the collective heat management device 30 to said premises 20.

Preferably, the method may include a calculation step of a predicted comfort cost, for a premises, as a function of a predetermined expected inside temperature, local variables and adjustment coefficients.

As illustrated in FIG. 1, a determination method according to the invention may additionally include a calculation step of expected savings in terms of the amount of thermal energy supplied to a premises as a function of modification of adjustment variable values.

Thus, when it implements the use of an adjustment variable, the method according to the invention may include a calculation step of what the amount of thermal energy supplied to a premises as a function of other adjustment variable values could be. For example, what the saving in terms of the amount of thermal energy supplied to a premises would be if the number of window openings was reduced by two could be calculated.

Such a step can then lead to the generation of recommendations for energy improvement actions and could allow users to reduce heating costs.

As illustrated in FIG. 1, a determination method according to the invention may additionally include a step 180 of transmitting data to an electronic display device 50.

The transmitted data may, for example, include the determined amount of thermal energy supplied.

According to another aspect, the invention relates to an allocator 10 for determining an amount of thermal energy supplied by a collective heat management device 30 to a premises 20 in a building 2, for a given period.

The allocator 10 may be an electronic device and may include one or more processors. Preferably, an allocator 10 according to the invention includes one or more processors configured to execute a method according to the invention, preferably the method 100 for determining an amount of thermal energy supplied, and its various preferred embodiments, whether advantageous or not.

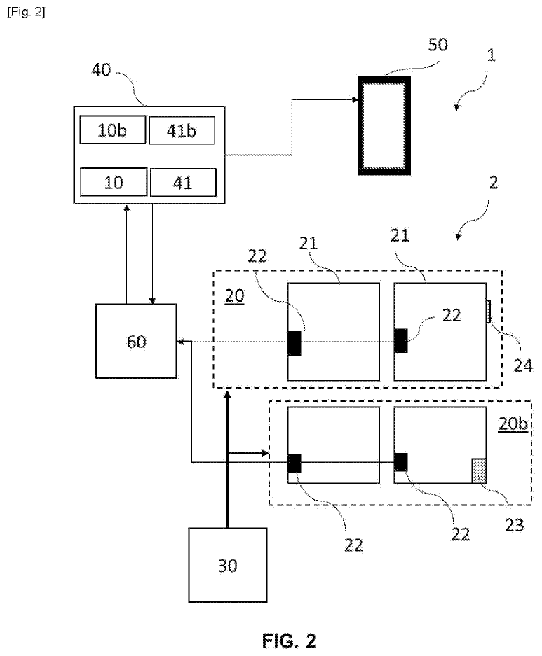

The allocator 10 may the installed in the building 2. However, as illustrated in FIG. 2, the allocator 10 may be located outside the building 2 housing the studied premises 20. For example, the allocator 10 may be a functional module of an electronic device, such as a functional module of a computer server. Under these conditions, a same computer server 40 may host a plurality of allocators 10, 10b each dedicated to a building 2. As illustrated in FIG. 2, the computer server 40 may also host the thermal simulation models 41, 41b having been used to calculate the heat loss coefficients used by the allocators 10, 10b. Alternatively and preferably, it is not necessary for the allocator to store the thermal simulation models used for generating the heat loss coefficients. More specifically, once a plurality of thermal coefficients has been generated, at least one per premises 20, the model if no longer essential to the determination of an amount of thermal energy supplied. This allows the applicant to propose a lighter and more responsive solution for real time calculations, without sacrificing the accuracy of the result.

The allocator 10, in particular the one or more processors of the allocator 10, are preferably configured to use a plurality of ambient temperature values of the building 2, a value of the temperature outside the building 2, a volume of the premises 20 and a heat loss coefficient of the premises, in order to determine an amount of thermal energy supplied by a collective heat management device 30 to a premises 20 in a building 2, for a given period.

Advantageously, the allocator 10 uses a heat loss coefficient of the premises calculated on the basis of a thermal simulation model 41 of the building 2, taking into account the geometry of the premises 20 and the composition of the walls and optionally the joinery composition of said premises 20.

In addition, the thermal simulation model 41 of the building 2 can take account of data representative of local solar radiation over the given period.

As has been described, preferably, the local solar radiation data are not measured, but taken into account, because they are generated on the basis of a model using local historic data.

The allocator 10 can, in particular, include one or more processors configured to calculate allocation data in order to allocate the financial costs associated with the collective heating as a function of all the quantities of supplied energy determined for each premises 20.

According to another aspect, the invention relates to a system 1 for allocating heating costs. The system 1 for allocating heating costs may include an electronic device equipped with one or more processors. Preferably, a system 1 for allocating heating costs according to the invention includes one or more processors configured to execute a method according to the invention, preferably the method 100 for determining an amount of thermal energy supplied, and its various preferred embodiments, whether advantageous or not.

In particular, a system 1 for allocating heating costs may include an allocator 10 according to the invention. As mentioned, this allocator can be supported by a computer server 40. In addition, the computer server 40 can be configured to communicate with an electronic display device 50 or any other electronic device capable of receiving data relating to heating costs or to the amount of thermal energy supplied to a premises.

In addition, a system 1 for allocating heating costs according to the invention may include a plurality of electronic temperature measurement devices 22. These devices may be electronic temperature measurement devices 22 dedicated to the system 1 for allocating heating costs according to the invention or else devices already present in a dwelling and configured to communicate data to the system 1 for allocating heating costs according to the invention. For example, these devices may be incorporated in smoke detectors or connected thermostats.

As illustrated in FIG. 2, the electronic temperature measurement devices 22 may be positioned in various zones or rooms 21 of a premises 20. For example, a plurality of electronic temperature measurement devices 22 may be positioned, in a same premises 20, in rooms 21 which may or may not include auxiliary heating means 23.

In particular, these electronic temperature measurement devices 22 may comprise sensors in addition to a temperature sensor. In particular, an electronic temperature measurement device 22 may include a humidity sensor. It may also include a CO2 sensor. With such sensors, the positioning of this electronic temperature measurement device 22 in a room including a window 24 can enable the generation of sufficient data to estimate the opening times of the window 24.

The electronic temperature measurement devices 22 will preferably be configured to send measured data directly or indirectly to the allocator 10. The temperatures may be measured at least once per day, preferably at least twice per day, more preferably at least every hour and more preferably at least every 30 minutes. By contrast, these data may be stored on the electronic temperature measurement device 22 and may be sent, directly or indirectly, to the allocator 10 at least once per month, preferably at least every week, more preferably at least every day and more preferably at least six times per day.

The electronic temperature measurement devices 22 will preferably be configured to send measured data directly to the allocator 10 via a wireless communication or a wired connection, most preferably via a wireless communication. Alternatively, these data may be sent via a wireless connection or a wired connection to a data collector 60.

The data collector 60 can, in particular, be situated in a common part of the building 2 or outside the building 2. When the system 1 includes a data collector 60, it may be configured to implement a first wireless communication, implemented in the building 2, between the data collector 60 and the electronic temperature measurement devices 22 associated with each premises on the one hand, and a second wireless communication, from the data collector 60 of the building 2 to an allocator 10, generally centralised and accessible via a communication network such as the Internet.

The invention may include numerous alternatives and applications other than those described above. In particular, unless indicated otherwise, the various structural and functional features of each of the implementations described above should not be considered as combined and/or as closely and/or inextricably linked to one another, but by contrast as simple juxtapositions. In addition, the structural and/or functional features of the various embodiments described above may be the subject, in whole or in part, of any different juxtaposition or any different combination.

1. A method for allocating energy costs in a collective building including a plurality of individual premises and at least one collective heat management device, the method being applicable to all the individual premises of the collective building and comprising determining an amount of thermal energy supplied by the at least one collective heat management device, to at least one of the individual premises of the collective building, over a given period, said determination, carried out by one or more processors, including the use of,
a thermal simulation model of the collective building which virtually represents the collective building and which takes into account, for each said individual premises, a geometry of the individual premises and a composition of the walls of the individual premises, as well as the heat exchange between various premises of the collective building,
a plurality of ambient temperature values of the collective building, the plurality of ambient temperature values of the collective building including a plurality of temperatures of the individual premises and a plurality of temperatures of premises or common spaces of the collective building which are adjacent to the individual premises,
one or more values of temperatures outside the collective building,
a volume of the individual premises, and
at least one heat loss coefficient of the individual premises, and
calculation of the at least one heat loss coefficient of the individual premises on the basis of the thermal simulation model of the collective building.

2. The method according to claim 1, wherein when said individual premises are additionally defined by a joinery composition, wherein the thermal simulation model of the collective building additionally takes into account the joinery composition.

3. The method according to claim 1, wherein the thermal simulation model of the collective building additionally takes into account data representative of local solar radiation over the given period.

4. The method according to claim 1, wherein the thermal simulation model of the collective building is a dynamic thermal simulation model of the collective building.

5. The method according to claim 1, wherein the at least one heat loss coefficient of the individual premises is selected from at least two predetermined heat loss coefficients, said predetermined heat loss coefficients each corresponding to a time period.

6. The method according to claim 1, wherein the determination of the amount of thermal energy supplied by the at least one collective heat management device to the at least one individual premises of the collective building, includes the use of one or more adjustment coefficients, each said adjustment coefficient being applied to an adjustment variable measured or calculated for the given period.

7. The method according to claim 6, wherein the adjustment variable is selected from: a variable representative of heat losses linked to the window openings, a variable representative of a level of occupation of the individual premises, a variable representative of meteorological conditions and/or a variable representative of a use of auxiliary heating.

8. The method according to claim 6, wherein the adjustment variable is measured directly in the individual premises of the collective building, modelled in a probabilistic manner on the basis of statistics, or reconstructed on the basis of measurements of machine learning algorithms.

9. The method according to claim 18, further comprising a calibration step of the thermal simulation model of the collective building, said calibration step being carried out on the basis of a first measurement period of ambient and outside temperature values and of a Bayesian calibration algorithm such that temperatures calculated by the thermal simulation model of the collective building reproduces as closely as possible the measured temperature values.

10. The method according to claim 1 wherein the ambient temperature of the individual premises corresponds to temperatures measured in a plurality of locations in the individual premises.

11. The method according to claim 1, further comprising a step of calculating individualised heating costs for a said individual premises of the collective building, as a function of a determined amount of thermal energy supplied by the collective heat management device to said individual premises.

12. The method according to claim 11, wherein the step of calculating individualised heating costs takes into account characteristics of orientation and positioning of the individual premises in the collective building, in such a way as to correct the disparities between the premises or common spaces of the collective building.

13. The method according to claim 1, wherein the calculation of at least one heat loss coefficient of the individual premises on the basis of a thermal simulation model of the building includes, for an individual premises, calculation of at least one heat loss coefficient on the basis of a plurality of simulations in which values for the geometry of the individual premises and composition of the walls have been modified in such a way as to incorporate uncertainties associated with the collective building.

14. The method according to claim 2, wherein the calculation of at least one heat loss coefficient of the individual premises on the basis of a thermal simulation model of the collective building includes, for a said individual premises, calculation of at least one heat loss coefficient on the basis of a plurality of simulations in which the joinery composition values have been modified in such a way as to incorporate uncertainties associated with the collective building.

15. The method according to claim 1, wherein the calculation of at least one heat loss coefficient of the individual premises on the basis of a thermal simulation model of the building includes, for a said individual premises, calculation of at least one heat loss coefficient on the basis of a plurality of simulations in which, in addition, values for use and/or meteorological conditions have been modified in such a way as to incorporate uncertainties associated with uses and with the meteorological conditions.

16. An allocator of energy costs in a collective building including a plurality of individual premises and at least one collective heat management device, the allocator being applicable to all the individual premises of the collective building and comprising determination of an amount of thermal energy supplied by the at least one collective heat management device to at least one individual premises of the collective building over a given period, said allocator comprising one or more processors configured to determine the amount of thermal energy supplied by using:
a thermal simulation model of the collective building which virtually represents the collective building and which takes into account, for each individual premises, a geometry of the individual premises and a composition of walls of the individual premises, as well as heat exchanges between various premises of the collective building,
a plurality of ambient temperature values of the collective building, the plurality of ambient temperature values of the collective building including a plurality of temperatures of the individual premises and a plurality of temperatures of premises or common spaces of the collective building which are adjacent to the individual premises,
one or more values of temperatures outside the collective building,
a volume of the individual premises, and
at least one heat loss coefficient of the individual premises, said wherein said allocator is configured to calculate the at least one heat loss coefficient of the individual premises on the basis of the thermal simulation model of the collective building.

17. The allocator according to claim 16, wherein when said individual premises are additionally defined by a joinery composition, the wherein the thermal simulation model of the collective building additionally takes into account the joinery composition.

18. A system for allocating heating costs including an allocator according to claim 16.
